(19) United States
(12) Patent Application Publication
(10) Pub. No.: US 2022/0234965 A1
(43) Pub. Date: Jul. 28, 2022

(54) CALCIUM PHOSPHATE COATED WITH HUMIC ACID OR PHENOLIC POLYMER AND USES THEREOF

(71) Applicants: INDUSTRY-ACADEMIC COOPERATION FOUNDATION GYEONGSANG NATIONAL UNIVERSITY, Gyeongsasangnam-do (KR); CONSIGLIO NAZIONALE DELLE RICHERCHE, Roma (IT)

(72) Inventors: Jong-rok JEON, Yuseong-gu (KR); Ho Young YOON, Gyeongsangnam-do (KR); Alessio ADAMIANO, Faenza (IT); Michele IAFISCO, FAENZA (IT)

(73) Assignees: INDUSTRY-ACADEMIC COOPERATION FOUNDATION GYEONGSANG NATIONAL UNIVERSITY, Gyeongsasangnam-do (KR); CONSIGLIO NAZIONALE DELLE RICHERCHE, Roma (IT)

(21) Appl. No.: 17/615,734

(22) PCT Filed: Jun. 7, 2019
(86) PCT No.: PCT/KR2019/006906

§ 371 Date: Dec. 1, 2021

(51) Int. Cl. C05G 5/30; C05G 1/00; C05F 11/02; C05B 17/00

(52) U.S. Cl. CPC C05G 5/37; C05B 17/00; C05F 11/02; C05G 1/00

(57) ABSTRACT

The present invention relates to a slow-releasing fertilizer composition and a composition for increasing plant growth and plant tolerance to salt stress which comprise, as an effective ingredient, hydroxyapatite or in mixture with a tricalcium phosphate obtained from chemical synthesis or thermal treatment of bones, coated with humic acid or a polymer of monomeric phenol.

### TECHNICAL FIELD

The present invention relates to calcium phosphate coated with humic acid or a phenolic polymer, and uses thereof. Korean inventors of this patent were supported by “R&D Program for Forest Science Technology (2017041B10-1919-BA01)” provided by Korea Forest Service (Korea Forestry Promotion Institute) and the Next-Generation BioGreen 21 Program (SSAC, grant No. PJ013195012019) of Rural Development Administration, Republic of Korea.

### BACKGROUND ART

Current agricultural farming employing conventional chemical NPK fertilizers has been in trouble with artificial factors such as low plant nutrient use efficiency, water eutrophication and soil devastation. As a result, the cost to increase crop productivity has been progressively increasing, thus creating concerns among farmers. In this context, much effort has been recently devoted to develop smart fertilizers capable of providing macro- and micronutrients very efficiently.

As one type of smart fertilizers, slow-releasing fertilizers currently received great attention. Slow-releasing fertilizers allow for gradual release of active ingredients of nutrient and/or pesticide, and thus they have an effect of reducing the frequency and number of applications of fertilizer and/or pesticide, saving labor force, and preventing environmental contamination. The use efficiency of a slow-releasing fertilizer is at least 50 to 55%, which is about 2 times higher than the use efficiency (28 to 33%) of a common chemical fertilizer. Thus, there is an increasing demand for development of a new sustained-release fertilizer having a release property that is suitable for different crops and different environments.

In this regard, see for example the Korean Patent Registration No. 1024187, “High strength and slow releasing solid fertilizer using calcium-linked hardening characteristic and method for producing the same”, and Korean Patent Registration No. 0865354, “Slow-releasing fertilizer for conifer and method for producing the same”.

To the best of our knowledge, multi-functional slow-releasing fertilizers that are able to exert several crop beneficial effects regarding nutrition supplying and abiotic stress relieving have not been reported yet. In this respect, particular attention should be paid to humic acid, whose plant stimulatory actions evoke several genetic and physiological functions associated with enhanced germination rates and abiotic stress resistance. Moreover, oxygen-based functional groups of humic acid allow for versatile adhesion onto solid surfaces; in this regard, see for example the papers “One-pot transformation of technical lignins into humic-like plant stimulants through Fenton-based advanced oxidation: Accelerating natural fungus-driven humification” Jeong, H. J. et al., ACS Omega, 2018, 3, 7441-7453, “Structure-property-function relationship in humic substances to explain the biological activity in plants” Garcia, A. C et al., Sci. Rep. 2016, 6, 20798 and “Humic acid as a sensitizer in highly stable dye solar cells: energy from an abundant natural polymer soil component” Vekariya, R. L et al., ACS Omega, 2016, 1, 14-18.

Hydroxyapatite is a calcium phosphate of formula Ca₅(PO₄)₃(OH). Hydroxyapatite applications in the agronomic filed are largely renown where it can exploit its potential in two different ways. First, as controlled release fertilizers of phosphorous; see for examples the paper “Synthetic apatite nanoparticles as a phosphorus fertilizer for soybean (Glycine max)” Liu & Lal, Sci. Rep. 2014, 4, 5686. Second, as carrier for the delivery of macronutrients and micronutrients; see for examples the paper “Urea-Hydroxyapatite Nanohybrids for Slow Release of Nitrogen” Kottegoda, N. et al, ACS Nano 2017, 11(2), 1214-1221.

In the first case, the mechanism of action is based on water dissolution of hydroxyapatite which is less soluble in aqueous media with respect to commercial fertilizers, thus allowing for a slower and more controlled release of P and other macro or micronutrients in the soil. In the second case, hydroxyapatite is loaded with other elements or molecules that are released from it with time.

Hydroxyapatite particles modified with citric acid attachments have resulted in different P releasing kinetics, thus offering P nutrients to crops in an optimized manner; see for examples the paper “Effect of citric acid surface modification on solubility of hydroxyapatite nanoparticles” Samavini, R. et al. J. Agric. Food Chem. 2018, 66, 3330-3337. In the paper by Liu & Lal previously cited instead, hydroxyapatite was coated with carboxylated methylcellulose to improve their colloidal stability in water and in turn increase their mobility in soil. However, the hydroxyapatite coated with humic acid or a phenolic polymer of the present invention and uses thereof have not yet been described. The objective of the present invention is to provide a material useful for plant fertilization and for plant stimulation, as well as to provide a process for its production, and fertilizer or other compositions for agricultural uses which comprise it.

### DISCLOSURE

### Technical Problem

The present invention is devised under the circumstances described in the above, and the inventors of the present invention produced hydroxyapatite in the form of powders, optionally in combination with powders of tricalcium phosphate, coated with humic acid, a polymer of catechol and gallic acid, or a polymer of catechol and ferulic acid. Hydroxyapatite and tricalcium phosphate are chemically synthesized or are produced starting from bones of any type, such as bones from fish both of sea and fresh water, and bones from poultry, bovine and porcine.

The inventors confirmed that, compared to hydroxyapatite powders having no coating treatment, the hydroxyapatite, possibly in combination with tricalcium phosphate, coated with humic acid or a phenolic polymer show increased concentration of solubilized phosphate that is released from it, and also that the coated humic acid or phenolic polymer can be released in a sustained manner. It was also confirmed that, as a result of treating a plant with the hydroxyapatite coated with humic acid or a phenolic polymer, enhanced plant growth and biomass are obtained compared to a group treated with commercially available phosphorus chemical fertilizer and a group treated with hydroxyapatite powder having no coating treatment, and also enhanced plant tolerance to salt stress are obtained, and the present invention is achieved accordingly.

### Technical Solution

In order to solve the problems described above, the present invention provides hydroxyapatite in the form of powders, possibly in combination with powders of tricalcium phosphate, coated with humic acid or a polymer derived from monomeric phenols.

The present invention further provides a slow-releasing fertilizer composition comprising as an effective ingredient the hydroxyapatite possibly mixed with tricalcium phosphate coated with humic acid or a polymer derived from monomeric phenols.

The present invention further provides a fertilizer for increasing plant growth produced by using the slow-releasing fertilizer composition.

The present invention further provides a method for increasing plant growth comprising treating a plant, a seed of a plant, or soil for growing a plant with the fertilizer for increasing plant growth.

The present invention further provides a composition for increasing plant tolerance to salt stress comprising as an effective ingredient the hydroxyapatite optionally mixed with tricalcium phosphate coated with humic acid or a polymer derived from monomeric phenols.

The present invention further provides a fertilizer for increasing plant tolerance to salt stress produced by using the composition for increasing plant tolerance to salt stress.

The present invention still further provides a method for increasing plant tolerance to salt stress comprising treating a plant, a seed of a plant, or soil for growing a plant with the fertilizer for increasing plant tolerance to salt stress.

### Advantageous Effects

The present invention has an excellent effect of enhancing plant growth by controlling solubilization degree of the phosphorus contained in hydroxyapatite and tricalcium phosphate according to their coating treatment with humic acid or a phenolic polymer, and allowing continuous effect of a fertilizer for quite a period of time even with single fertilizer application. As such, it is expected that the hydroxyapatite, possibly mixed with tricalcium phosphate, coated with humic acid or a phenolic polymer of the present invention is advantageously used for developing a fertilizer for agricultural use which enables enhancement of high-quality crops and farmhouse income while reducing the environmental contamination. Furthermore, since the hydroxyapatite and the tricalcium phosphate coated with humic acid or a phenolic polymer of the present invention can simultaneously release, in a sustained-release manner, not only the solubilized phosphorus but also humic acid or a phenolic polymer, it can increase the plant tolerance against various non-biological stresses such as salt, high temperature, or low temperature. Therefore, the hydroxyapatite, possibly mixed with tricalcium phosphate and coated with humic acid or a phenolic polymer of the present invention can be advantageously used for plants that are cultivated in high-salt area or seashore area, or in an area with abnormal temperatures.

### DESCRIPTION OF DRAWINGS

FIG. 1 is a photographic image showing an outer appearance of the non-coated hydroxyapatite (CaP) (A, white-colored powder) as prepared, CaP coated with 0.01 g/ml humic acid (Y1; B, brown-colored powder), CaP coated with 0.1 g/ml humic acid (Y2; C, brown-colored powder), CaP coated with 0.05 g/ml humic acid (Y3; D, brown-colored powder), CaP coated with a polymer of catechol and gallic acid (S1; E, black-colored powder), and CaP coated with a polymer of catechol and ferulic acid (S2; F, gray-colored powder).

FIG. 2 shows the result of X-ray diffraction (XRD) pattern of the non-coated hydroxyapatite (CaP), CaP coated with 0.01 g/ml humic acid (Y1), CaP coated with 0.1 g/ml humic acid (Y2), CaP coated with 0.05 g/ml humic acid (Y3), CaP coated with a polymer of catechol and gallic acid (S1), and CaP coated with a polymer of catechol and ferulic acid (S2).

FIG. 3 shows a curve graph obtained by thermogravimetric analysis (TGA) of the non-coated hydroxyapatite (CaP), CaP coated with a polymer of catechol and gallic acid (S1), CaP coated with 0.1 g/ml humic acid (Y2), CaP coated with a polymer of catechol and ferulic acid (S2), CaP coated with 0.01 g/ml humic acid (Y1), and CaP coated with 0.05 g/ml humic acid (Y3).

FIG. 4 shows images of the non-coated hydroxyapatite (CaP), CaP coated with 0.01 g/ml humic acid (Y1), CaP coated with 0.1 g/ml humic acid (Y2), CaP coated with 0.05 g/ml humic acid (Y3), CaP coated with a polymer of catechol and gallic acid (S1), and CaP coated with a polymer of catechol and ferulic acid (S2), in which the photographic image is obtained with a transmission electron microscope (TEM; A) or a scanning electron microscope (SEM; B).

FIG. 5A shows the result of measuring the concentration of solubilized phosphate released from hydroxyapatite which have been coated with commercially available humic acid or a phenolic polymer, and FIG. 5B shows the result of measuring the amount of humic acid released from hydroxyapatite which have been coated with commercially available humic acid or a phenolic polymer, in which the measurement is carried out using vanadomolybdate assay. CaP; hydroxyapatite nanoparticle-treatment group in which the CaP has not been coating-treated. Y1; CaP-treatment group in which the CaP has been coated with humic acid at concentration of 0.01 g/ml. Y2; CaP-treatment group in which the CaP has been coated with humic acid at concentration of 0.1 g/ml. Y3; CaP-treatment group in which the CaP has been coated with humic acid at concentration of 0.05 g/ml. S1; CaP-treatment group in which the CaP has been coated with a polymer of catechol and gallic acid. S2; CaP-treatment group in which the CaP has been coated with a polymer of catechol and ferulic acid.

FIG. 6 and FIG. 7 are graphs illustrating plant height, fresh weight, and dry weight of corn after application with a test sample in which corn is employed as a model plant. Specifically, FIG. 6 is a graph showing the plant height (A), fresh weight(B), and dry weight(C) of corn after applying CaP coated with commercially available humic acid or a phenolic polymer, and FIG. 7 is a graph showing (A): the fresh weight per phosphorus unit(P), and (B): the dry weight per phosphorus unit(P) when soil is supplied with the different fertilizers. The different treatment groups are identified as follows. Commercial-NPK; group treated with commercially available inorganic fertilizer (N; urea, P; fused superphosphate, K; potassium chloride), CaP—NK; group treated with CaP having no coating treatment and NK fertilizer(urea, potassium chloride), Y1-NK; group treated with CaP, which are coated with humic acid at concentration of 0.01 g/ml, and NK fertilizer(urea, potassium chloride), Y2-NK; group treated with CaP, which are coated with humic acid at concentration of 0.1 g/ml, and NK fertilizer, Y3-NK; group treated with CaP, which are coated with humic acid at concentration of 0.05 g/ml, and NK fertilizer, S1; group treated with CaP, which are coated with a polymer of catechol and gallic acid, and NK fertilizer, S2; group treated with CaP, which are coated with a polymer of catechol and ferulic acid, and NK fertilizer.

FIG. 8 and FIG. 9 show the result of measuring the plant height, fresh weight, and dry weight of corn after inducing salt stress in corn as a model plant followed by a treatment with test sample. Specifically, FIG. 8 is a graph showing the plant height (A), fresh weight(B), and dry weight(C) of corn after applying CaP coated with commercially available humic acid or a phenolic polymer, and FIG. 9 is a graph showing (A): the fresh weight per unit phosphorus(P), and (B): the dry weight per unit phosphorus(P) when soil is supplied with the phosphorus.

### MODE FOR INVENTION

To achieve the object of the present invention, the present invention provides calcium phosphate in the form of hydroxyapatite optionally mixed with tricalcium phosphate, coated with humic acid or a polymer derived from monomeric phenols.

The materials produced and used in the invention are hydroxyapatite, of formula Ca₅(PO₄)₃(OH) (often also reported as its dimer Ca₁₀(PO₄)₆(OH)₂, which reflects the presence of two basic formula units in the elementary cell of the crystal), possibly in mixture with tricalcium phosphate. Tricalcium phosphate, when present, is generally in the form of its β polymorph, the one stable at lower temperatures: this compound also exists in the form of polymorphs α and α′, but these are only formed at much higher temperatures than those of the process of the invention. Compound β-Ca₃(PO₄)₂ is also referred to in the literature by the abbreviation β-TCP, which will also be used in the present description. The abbreviation CaP, that is often used to refer generally to calcium phosphates, will be used herein to identify hydroxyapatite or its mixture with β-TCP, where the CaP is synthesized from calcium and phosphorous reagents, or is obtained by thermal treatment of animal bones.

The term “material of the invention” will therefore be understood generically, unless otherwise specified, hydroxyapatite, or possibly a mixture of hydroxyapatite and β-Ca₃(PO₄)₂, coated with humic acid or a polymer derived from monomeric phenols.

Furthermore, the material of the present invention has a core-shell structure in which hydroxyapatite and optionally β-TCP as core materials are surrounded by humic acid or a polymer derived from monomeric phenols.

As described herein, the term “humic acid” indicates a humic substance which is a brown or black acidic organic substance extractable from coal-related resources such as lignite and leonardite, or decomposed organic products deposited in regular soils and peat, and which can be dissolved at pH 2.0 or higher. Various functional groups of humic acid, i.e., a carboxyl group, an alcoholic group, a phenol group, and an enol group, undergo adsorption with hydrophobic or hydrophilic materials, and chemical reaction like oxidation-reduction reaction.

With regard to the material of the present invention, the polymer of monomeric phenol may be a copolymer or a homopolymer which is produced by polymerizing, using an oxidizing agent, one or more monomers selected from a group consisting of L-3,4-dihydroxyphenylalanine, catechol, vanillic acid, catechin, ferulic acid, guaiacol, resorcinol, tannic acid, pyrogallol, gallic acid, chlorogenic acid, quercetin, and resorcinol, but it is not limited thereto.

With regard to the material of the invention, according to one embodiment of the present invention, the polymer derived from monomeric phenols is preferably a copolymer which is produced by co-polymerizing a mixture of catechol and gallic acid, or a mixture of catechol and ferulic acid using an oxidizing agent, and it can be more preferably produced by mixing catechol and gallic acid monomers, each in the same amount, or mixing catechol and ferulic acid monomers, each in the same amount, but it is not limited thereto.

The homopolymer or copolymer of the present invention can be produced by a method for producing an oxidized polymer of a phenolic compound well known in the pertinent art.

For producing the polymer of monomeric phenol of the present invention, the catechol, gallic acid, and ferulic acid are not limited to those that are commercially available according to synthesis and separation thereof.

For producing the polymer of monomeric phenol of the present invention, the oxidizing agent may be one or more selected from a group consisting of copper (I) chloride, ammonium persulfate, sodium periodate, potassium chloride, and an oxidizing enzyme, in which the oxidizing agent may be peroxidase, laccase, or a mixture thereof, but it is not limited thereto. Examples of the laccase include those originated from microorganisms such as Trametes versicolor, Fomes fomentarius, Chaetomium thermophile, Neurospora crassa, Colorius versicol, Botrytis cinerea, Rigidoporus lignosus, Ganoderma lucidum, Coriolus hirsutus, Russula delica, Pleurotos ostreatus, or Aspergillus nidulans, but it is not limited thereto.

The polymer of monomeric phenols of the present invention is characterized by average molecular weight of 5,000 or higher. The term “average molecular weight” may mean a value which is measured by GPC (Gel Permeation Chromatography) and calibrated against standard polystyrene. In the present specification, unless specifically defined otherwise, the term “molecular weight” means “average molecular weight”.

Because the CaP coated with humic acid or a polymer derived from monomeric phenols of the present invention has an excellent effect of releasing gradually the active ingredients (phosphorus, humic acid, or polymer derived from monomeric phenols) into soil and rhizosphere, it has advantages that a fertilizer or a pesticide containing the coated CaP can be applied in an economically favorable way, and also the environmental contamination can be prevented by lowering the number and frequency of application of a fertilizer or a pesticide and labor force required for the application can be saved.

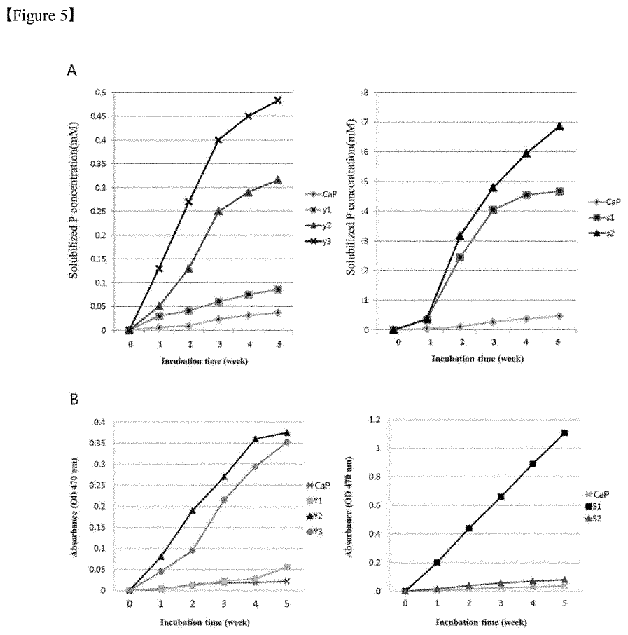

Specifically, when CaP is coated with 0.1 g/ml or 0.05 g/ml humic acid, a polymer of catechol and gallic acid, or a polymer of catechol and ferulic acid, releasing kinetics of solubilized phosphate can be readily tuned (see, FIG. 5A), and releasing kinetics of coated humic acid or polymer of catechol and gallic acid can be readily tuned (see, FIG. 5B), but it is not limited thereto.

The present invention further provides a slow-releasing fertilizer composition comprising as an effective ingredient hydroxyapatite and possibly β-TCP coated with humic acid or a polymer derived from monomeric phenols.

As described herein, the expression “slow-releasing fertilizer” means a fertilizer which exhibits, based on gradual release of fertilizer components that are required by crops, continuous effect of a fertilizer during entire growth period or certain growth period of crops.

With regard to the slow-releasing fertilizer composition of the present invention, the CaP coated with humic acid or a polymer derived from monomeric phenols is the same as the CaP explained in the above.

The slow-releasing fertilizer composition of the present invention has an excellent effect of promoting growth of a plant, and thus it can be used as a nutritional agent for a plant, a soil improving agent, a composting agent, an agent for spraying on leaf surface, an agent applied by irrigation, or the like.

The slow-releasing fertilizer composition of the present invention may contain an agriculturally acceptable carrier, and examples thereof include a filler, a solvent, a vehicle, a surfactant, a suspending agent, a spreader, an adhesive, an anti-foaming agent, a dispersant, a wetting agent, a drift reducing agent, auxiliaries, an adjuvant, or a mixture of them.

The slow-releasing fertilizer composition of the present invention may be formulated into a formulation type such as a concentrate, a solution, a spray, an aerosol, an immersion bath, a dip, an emulsion, a concentrated suspension solution, a gel, or a granule.

The slow-releasing fertilizer composition of the present invention may be used either singly or blended with other agricultural preparations such as pesticides, insecticides, acaricides, fungicides, bactericides, herbicides, antibiotics, antimicrobials, nematocides, rodenticides, entomopathogens, pheromones, attractants, plant growth regulators, plant hormones, insect growth regulators, chemosterilants, microbial pest control agents, repellents, viruses, phagostimulents, nutritional agents for plant, plant fertilizers, or biological control gents, or they may be used in turn.

Examples of the insecticides which may be used include insecticides like carbamate, organic phosphate, organic chlorine insecticides, phenylpyrazole, pyrethroid, neonicotinoid, spinosin, avermectin, milbemycin, juvenile hormone analogs, alkyl halide, organotin compound, nereistoxin analogs, benzoylurea, diacyl hydrazine, and METI (mitochondria electron transport inhibitor) acaricides, and insecticides like chloropicrin, pymetrozine, flonicamid, clofentezine, hexythiazox, etoxazole, diafenthiuron, propargite, tetradifon, chlorfenapyr, DNOC, buprofezin, cyromazine, amitraz, hydramethylnon, acequinocyl, fluacrypyrim, rotenone, or derivatives thereof.

As for the nutritional agent for a plant, a fertilizer commonly used for supplying nutrients to a plant may be used.

Furthermore, as for the fertilizer, an organic fertilizer, a composite fertilizer, a nitrogen fertilizer, a phosphate fertilizer, a calcium fertilizer, a lime fertilizer, a siliceous fertilizer, a magnesium fertilizer, a trace element fertilizer, an excrement-based fertilizer, or the like may be used. In that case, specific examples of the agricultural preparation would be evident to a person who has common knowledge in the pertinent art, and they can be easily obtained.

When the fertilizer composition of the present invention is applied to a plant, the application can be made with the application amount and application method that are commonly known in the pertinent art.

The present invention further provides a fertilizer for increasing plant growth that is produced by using the slow-releasing fertilizer composition. The slow-releasing fertilizer composition contains hydroxyapatite and possibly β-TCP coated with humic acid, or with a copolymer which is produced by polymerizing a mixture of catechol and gallic acid or a mixture of catechol and ferulic acid using an oxidizing agent, and, when a plant is treated with the fertilizer for increasing plant growth, an effect of increasing the growth and biomass of a plant is obtained.

The present invention further provides a method for increasing plant growth comprising treating a plant, a seed of a plant, or soil for growing a plant with the fertilizer for increasing plant growth.

The method of the present invention uses the fertilizer for increasing plant growth which is produced by using the slow-releasing fertilizer composition described above, and further descriptions of the slow-releasing fertilizer composition are omitted to avoid excessive complexity of the present specification.

The method for increasing plant growth can be carried out by immersing or irrigating a plant with the fertilizer for increasing plant growth, namely, by spraying the fertilizer for increasing plant growth. In case of the immersion, the fertilizer may be poured to soil around a plant, or a seed of a plant may be immersed in the composition, but it is not limited thereto.

According to the method of the present invention, any plant grown as agricultural crops may be employed as the plant.

The present invention further provides a composition for increasing plant tolerance to salt stress comprising the hydroxyapatite and possibly β-TCP coated with humic acid or a polymer of monomeric phenol.

With regard to the composition for increasing plant tolerance to salt stress of the present invention, the hydroxyapatite and hydroxyapatite/β-TCP mixture coated with humic acid or a polymer of monomeric phenol is the same as the one described above.

The present invention still further provides a method for increasing plant tolerance to salt stress comprising treating a plant, a seed of a plant, or soil for growing a plant with the composition for increasing plant tolerance to salt stress.

The method for increasing plant tolerance to salt stress can be carried out by immersing or irrigating a plant with the composition for increasing plant tolerance to salt stress which comprises as an effective ingredient hydroxyapatite and possibly β-TCP coated with humic acid or a polymer derived from monomeric phenols of the present invention, namely, by spraying the composition for increasing plant tolerance to salt stress. In case of the immersion, the fertilizer may be poured to soil around a plant, or a seed of a plant may be immersed in the composition, but it is not limited thereto.

Herein below, the present invention is explained in detail based on Examples. However, the following Examples are given only for exemplification of the present invention, and scope of the present invention is not limited to them.

Methods and Instruments

1. Synthesis of Calcium Phosphate Particles

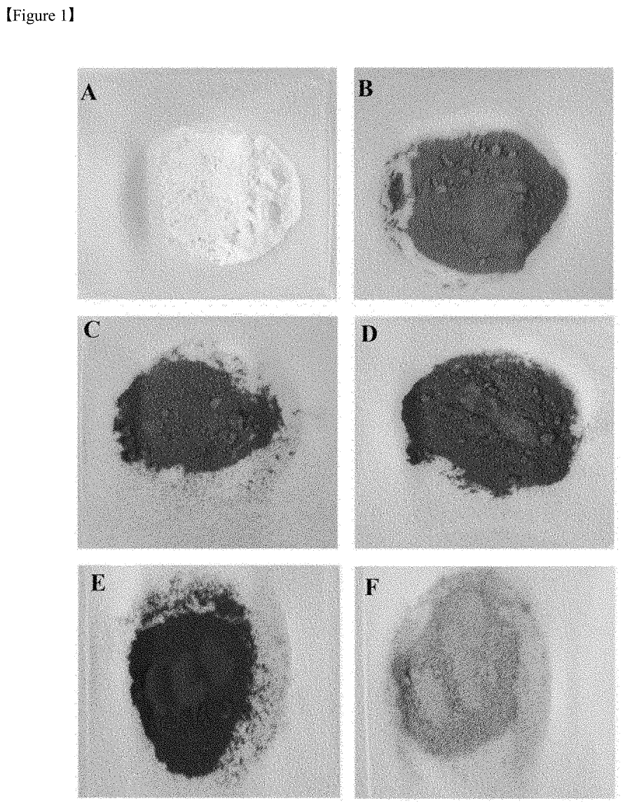

Briefly, 10 g of Ca(OH)₂ (purity >95%, Sigma-Aldrich) are added to 100 ml of Millipore water and then stabilized at room temperature under constant stirring at 400 rpm for 30 min. A solution obtained mixing 8.87 g of H₃PO₄ (85 wt %; Merck) with 30 ml DI water is added drop-wise into the Ca(OH)₂ suspension. The molar ratio between calcium and phosphorous is set to 1.67 and kept constant for all the synthesis. Once the drop-wise addition of phosphoric acid is completed, the solution is kept at room temperature under constant stirring at 400 rpm for 3 hours and then left still overnight. Finally, the obtained powder is repeatedly washed with water and then air-dried at 40° C. until constant weight(FIG. 1A).

2. In a variant process of the invention, calcium phosphate powders are obtained from the thermal treatment of bones in an oxidizing atmosphere at a temperature between 200° C. and 1200° C. for a time between 30 minutes and 8 hours. After cooling to a temperature lower than 200° C., the materials are grinded and sieved at 500 μm.

In this variant of the process of the invention it is possible to use bones of any type, such as bones from fish both of sea and fresh water, and bones from poultry, bovine and porcine.

3. Coating of CaPs with Humic Acid

Three different concentrations of commercial humic acid (Mycsa AG, USA; Y1, 0.01 g/ml, FIG. 1B; Y2, 0.1 g/ml, FIG. 1C; Y3, 0.05 g/ml, FIG. 1D) were dissolved in distilled waters followed by the centrifugation (13,000 rpm, 5 min) to remove the insoluble pellets. CaPs (1 g) were totally dispersed in the soluble humic solution (9.9 ml) to induce coating of humic acids on the nano-sized hydroxyapatites by employing vigorous vortexing followed by roller-shaking (60 rpm, 20 min).

The coated particles with the humic acids were harvested through centrifugation (13,000 rpm, 10 min). Fresh distilled water was then used for vigorous vortexing to remove loosely attached humic acids from CaPs. After re-harvesting the particles through the centrifugation (13,000 rpm, 10 min), water contents were completely evaporated through drying at 55° C. The powders were finally grinded with a mortar and pestle.

4. Coating of CaPs with a Phenolic Polymer

Artificial humification based on oxidative polymerization of lignin-derived phenols was performed as described previously. Briefly, either catechol (0.1 g) and gallic acid (0.1 g; 51, FIG. 1E) or catechol (0.1 g) and ferulic acid (0.1 g; S2, FIG. 1F) was oxidized with fungal laccase enzymes (2.65 mg; sigma) overnight in 100 mM sodium acetate buffer containing 20% EtOH (40 ml) at room temperature. The polymerized solutions were directly used for CaPs coating and other procedures were same to those of commercial humic acids.

5. Chemical Analysis

Calcium and phosphate contents were determined using inductively coupled plasma optical emission spectrometry (ICP-OES) on a Liberty 200 spectrometer (Agilent Technologies 5100 ICP-OES, Santa Clara, Calif., USA) employing wavelengths of 422.673 (Ca) and 213.618 nm (P). Twenty mg of dried samples were dissolved in 50 ml of 2 wt % HNO₃ (puriss. p.a.≥65%, Sigma-Aldrich St. USA) or 2 wt % HCl (puriss. p.a≥37%, Sigma-Aldrich St. USA) solutions prior to the analysis.

6. X-Ray Diffraction Analysis

The phase composition of each powder was determined by XRD with a D8 Advance Diffractometer (Bruker, Karlsruhe, Germany) equipped with a Lynx-eye position sensitive detector using Cu Kα radiation (λ=1.54178Δ) generated at 40 kV and 40 mA. XRD spectra were recorded in the 2θ range from 10-80° with a step size (2θ) of 0.04° and a counting time of 0.5 s. In case of a quantitative evaluation of the phase compositions and cell parameters, a step size of 0.02° was used.

7. Zeta Potential and Size Measurements

Zeta-potential distributions of dried powders suspended in deionized Millipore® water were measured by dynamic light scattering (DLS) with a Zetasizer Nano ZS (Malvern Ltd, Worcestershire, UK) and were quantified by laser Doppler velocimetry as electrophoretic mobility using disposable electrophoretic cell (DTS1061, Malvern Ltd, Worcestershire, UK). Ten runs of 30 s were performed for each measurement and four measurements were carried out for each sample. Zeta average values were obtained suspending the dry powders in the same media at a concentration of 1.0 mg/ml. Twenty runs of 30 s each were collected in each measurement and for each sample.

8. TEM and SEM Analysis

The samples morphology and size in a dry state were analyzed on a FEI Tecnai F20 transmission electron microscopy (TEM) equipped with a Schottky emitter and operating at 120 and 200 keV. Ten microliters of material suspended in 0.1 wt % citrate buffer at 10.0 mg/ml were dissolved in 5 ml of isopropanol and treated with ultrasound. A droplet of the resulting finely dispersed suspensions was evaporated at room temperature and under the atmospheric pressure on a holey carbon film supported on a copper grid.

The morphology of the samples was also analyzed by a scanning electron microscopy (SEM, FEI Quanta 200, Eindhoven, The Netherlands). The powders were mounted on aluminum stubs using carbon tape, and sputter coated with gold in a Sputter Coater E5100 (Polaron Equipment, Watford, Hertfordshire, UK) under argon at 10-3 mbar for 4 minutes with a sputtering current of 30 mA.

9. TGA Analysis

Thermogravimetry analyses (TGA) were performed using a STA 449F3 Jupiter (Netzsch GmbH, Selb, Germany) apparatus. About 10 mg of sample was weighted in an alumina crucible and heated from room temperature to 1100° C. under air flow with a heating rate of 10° C./min.

10. Phosphate and Humic Acid or a Polymer of Monomeric Phenols Releasing

To quantify solubilized phosphate ions and detached humic-related materials in a time-dependent manner, either CaPs or humic structure-modified particles (1 g) were completely dispersed in autoclaved distilled waters (40 ml). One milliliter of the mixtures was weekly taken for standard vanadomolybdate assays with UV-visible spectrophotometer (470 nm). Before the vanadomolybdate-based colorations, the solutions were sedimented through 13,000 rpm centrifugation to exclude the particles and their absorbance at 470 nm were monitored to quantitatively measure reversely detached humic acid or a polymer of monomeric phenols as well as to compensate the corresponding absorbance of the vanadomolybdate-based colorations

To avoid the saturation of calcium and phosphate ions in the given water volume as well as to mimic concomitant utilization of the solubilized ions with plants and soil microbes, fresh distilled waters were weekly replenished. The release pattern of phosphate ions was graphed via piling of the calculated phosphate ions per a week.

11. Plant Growth, Biomass, and Salt Stress Tolerance Analysis

Corn seeds (Zea mays) were sown in a pot, and each tested materials was blended approximately 5 cm under the surface of culture soil in the pot. These were: commercially available inorganic fertilizer(NPK)(N, 211.3 mg, urea, Super Al-al-ee, Namhae Chemical Corporation; P, 184.5 mg, fused superphosphate, Fused Superphosphate, Nonghyup; K, 129.2 mg, potassium chloride, Potassium chloride, Enpico); CaP having no coating treatment and NK fertilizer; CaP coated with commercial humic acid at concentration of 0.01 g/ml (Y1), 0.1 g/ml (Y2), or 0.05 g/ml (Y3) and NK fertilizer; CaP coated with a polymer of catechol and gallic acid and NK fertilizer; and CaP coated with a polymer of catechol and ferulic acid and NK fertilizer. In addition, commercial fused superphosphate was used as a positive control. Same amounts of waters were supplied under a 16 h/8 h light/dark cycle at 23° C. in a growth chamber. Early growth rates of the Zea mays were evaluated via measuring the weights of fresh and dried biomasses after 20 days. Biomass increase per unit amount of P supplied in soils was calculated based on ICP-OES-driven quantification of phosphorus in pure CaPs and humic acid or a polymer of monomeric phenols-coated CaPs.

Sodium chloride (3 g) was vigorously mixed with soil particles (970 g) to induce salt-based abiotic stress to seedlings of Zea mays which was previously germinated in seedbed soils. Early growth rates in the presence of NaCl were also evaluated in terms of fresh, dry and unit amount of P as did in the nutrition tests.

### Example 1. X-Ray Diffraction Analysis

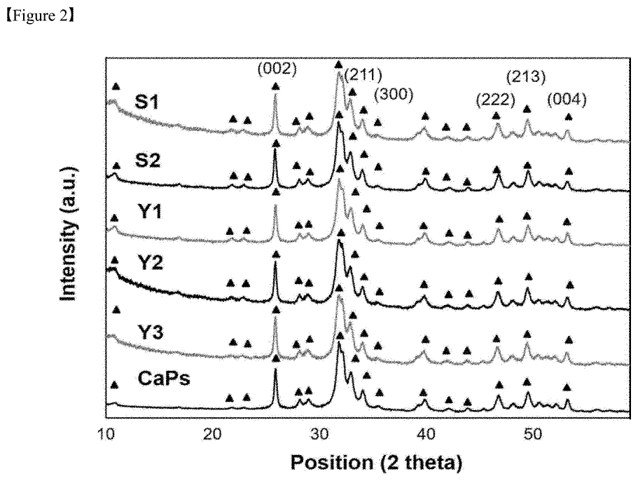

By having synthetic non-coated hydroxyapatite (CaP), CaP coated with a polymer of catechol and gallic acid (S1), CaP coated with a polymer of catechol and ferulic acid (S2), CaP coated with 0.01 g/ml humic acid (Y1), CaP coated with 0.1 g/ml humic acid (Y2), and CaP coated with 0.05 g/ml humic acid (Y3) as a subject, X-ray diffraction analysis was carried out. As a result, CaP, S1, S2, Y1, Y2, and Y3 exhibited the same X-ray diffraction pattern, and they were confirmed to be in the form of carbonated hydroxyapatite with low crystallinity (crystalline carbonated hydroxyapatite; JCPDS no. 09-432)(FIG. 2). These results indicate that the crystallinity does not change even when the surface of CaP is modified with an organic layer through a coating process.

### Example 2. TGA and ICP-OES Analyses

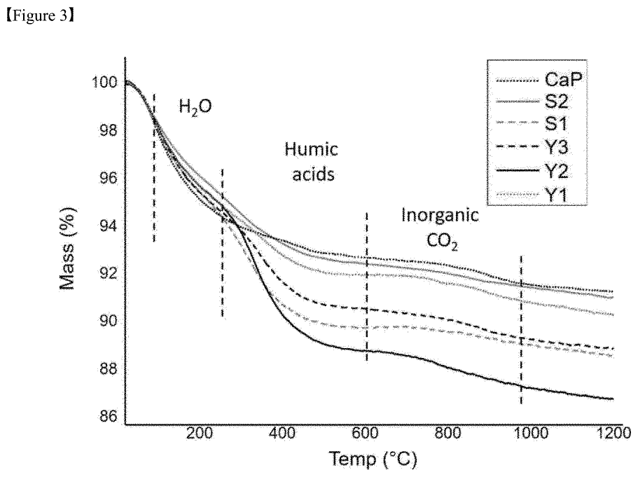

By having synthetic non-coated hydroxyapatite (CaP), CaP coated with a polymer of catechol and gallic acid (S1), CaP coated with a polymer of catechol and ferulic acid (S2), CaP coated with 0.01 g/ml humic acid (Y1), CaP coated with 0.1 g/ml humic acid (Y2), and CaP coated with 0.05 g/ml humic acid (Y3) as a subject, TGA (FIG. 3) and ICP-OES analyses were carried out, and the compositions determined from the analyses are shown in the following Table 1. Based on the results, it was found that about 1 to 5% (in terms of wt %) of an organic layer is attached to the surface of hydroxyapatite.

TABLE 1
Results of TGA and ICP-OES analyses

| | CaPs | S1 | S2 | Y1 | Y2 | Y3 |
|---|---|---|---|---|---|---|
| Ca(wt %) | 34.5 ± 1.7 | | | | | |
| P(wt %) | 16.0 ± 0.8 | | | | | |
| CO₂(wt %) | 1.0 | 1.0 | 0.8 | 1.0 | 1.2 | 1.2 |
| Ca/P(mol) | 1.66 | | | | | |
| Physisorbed water(wt %) | 3.5 | 2.1 | 3.5 | 3.0 | 3.2 | 3.5 |
| Humic acids(wt %) | | 3.95 | 1.20 | 1.32 | 4.91 | 3.37 |

### Example 3. TEM and SEM Analyses

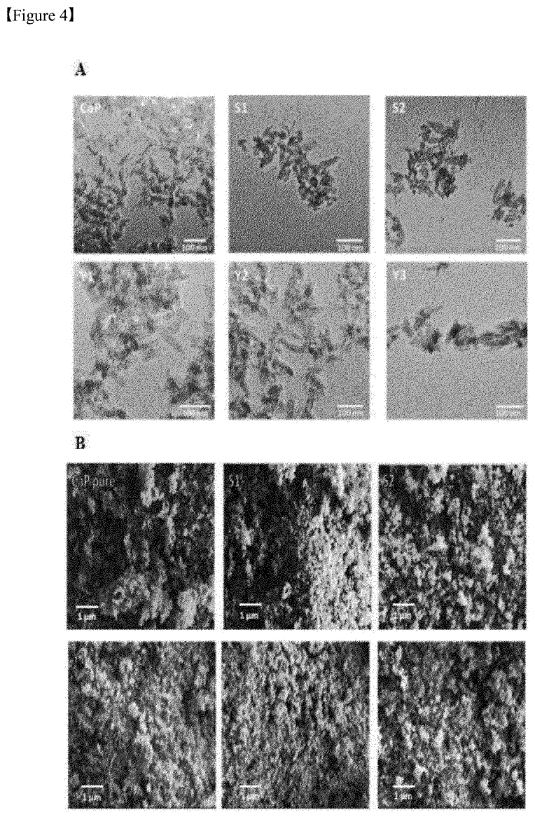

As a result of the TEM analysis, it was found that all of the non-coated CaP, CaP coated with a polymer of catechol and gallic acid (S1), CaP coated with a polymer of catechol and ferulic acid (S2), CaP coated with 0.01 g/ml humic acid (Y1), CaP coated with 0.1 g/ml humic acid (Y2), and CaP coated with 0.05 g/ml humic acid (Y3) are composed of particles having almost the same size with long axis of 35 to 45 nm (FIG. 4A). These results are in match with the size and shape of crystal form that are estimated from the XRD analysis.

Furthermore, similar to the above results of TEM analysis, it was also confirmed from the results of SEM analysis that the non-coated CaP and CaP coated with humic acid or a phenolic polymer have no significant difference in terms of size and shape (FIG. 4B).

### Example 4. DLS and BET Analyses

Zeta-potential was measured by utilizing the principle of dynamic light scattering (DLS). Non-coated CaP shows Zeta-potential close to neutral, but CaP coated with humic acid or a phenolic polymer showed a negative charge. In this regard, it is recognized that this negative charge is related with the oxygen-based organic functional group shown in the humic acid and phenolic polymer.

As a result of specific surface area (SSA) analysis utilizing the Brunauer-Emmett-Teller (BET) principle, an almost similar value was obtained from both the non-coated CaP and coated CaP. However, a phenomenon showing a significantly decreased hydrodynamic diameter was observed from the coated CaP compared to the non-coated CaP. In this regard, it is believed that, due to the increased surface negative charge, aggregation among CaP is prevented in an aqueous system so that the stabilization is induced (Table 2).

TABLE 2
Results of DLS and BET analyses

| | CaPs | S1 | S2 | Y1 | Y2 | Y3 |
|---|---|---|---|---|---|---|
| ζ-potential | −1.7 ± 0.1 | −18.5 ± 0.2 | −8.4 ± 0.2 | −19.8 ± 0.6 | −31.7 ± 0.2 | −22.8 ± 0.3 |
| zeta average(nm) | 3,107 ± 40 | 414 ± 27 | 1,947 ± 134 | 781 ± 84 | 688 ± 51 | 510 ± 43 |
| PDI | 0.2 | 0.5 | 0.2 | 0.5 | 0.5 | 0.5 |
| SSA(m²/g) | 88.5 ± 4.0 | 85.1 ± 4.0 | 86.3 ± 4.2 | 94.3 ± 4.9 | 89.2 ± 4.2 | 93.4 ± 4.5 |

### Example 5. Measurement of Concentration of Solubilized Phosphate Released from CaP Coated with Humic Acid or a Phenolic Polymer

As a result of measuring for 5 weeks the concentration of solubilized phosphate released from CaP that are coated with humic acid or a phenolic polymer, it was observed that the concentration of solubilized phosphate is significantly increased in the group treated with CaP coated with humic acid at different concentrations or the group treated with CaP coated with a phenolic polymer, compared to the group treated with CaP having no coating treatment (FIG. 5A).

Furthermore, as a result of measuring for 5 weeks the concentration of humic structures released from CaP coated with commercially available humic acid or a phenolic polymer, it was confirmed that the humic-related materials (i.e., humic acid or phenolic polymer) is slightly released from CaP coated with 0.01 g/ml humic acid (Y1) or a polymer of catechol and ferulic acid (S2) within the 5th week, but the humic-related materials are significantly released from CaP nanoparticle coated with 0.1 g/ml humic acid (Y2), 0.05 g/ml humic acid (Y3), or a polymer of catechol and gallic acid (S1). In particular, it was confirmed that the humic-related materials are released at constant dissolution speed from CaP that are coated with a polymer of catechol and gallic acid (FIG. 5B).

These results indicate that the property of releasing solubilized phosphorus of hydroxyapatite can be controlled by coating of humic acid or a phenolic polymer, and it further suggests that simultaneous release of a humic structure capable of inducing plant stimulation can be achieved

### Example 6. Analysis of Effect of Increasing Plant Growth According to Treatment with CaP that are Coated with Humic Acid or a Phenolic Polymer

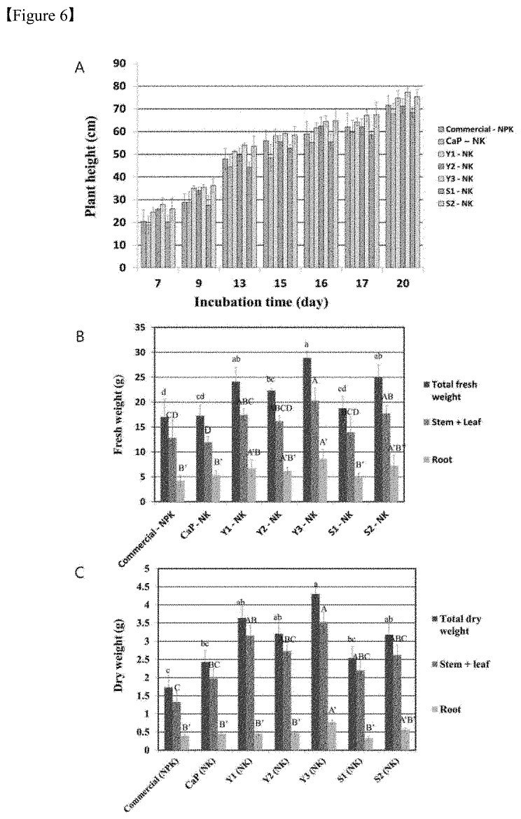

By using corn (Zea mays) as a model plant, the effect of promoting plant growth and increasing biomass by CaP coated with humic acid and a phenolic polymer was analyzed. As a result, it was confirmed that an increase in the fresh weight(FIG. 6B) and dry weight(FIG. 6C) of the corn is observed from the group treated with CaP(NK) coated with humic acid and the group treated with CaP(NK) coated with a phenolic polymer compared to the group treated with commercially available inorganic phosphorous fertilizer (NKP) treatment group and CaP(NK), although the plant height (FIG. 6A) of all the treatment groups appears to be similar. In addition, the increase level of the weights was similar between the group treated with CaP(NK) coated with a phenolic polymer and the group treated with CaP(NK) coated with commercially available humic acid.

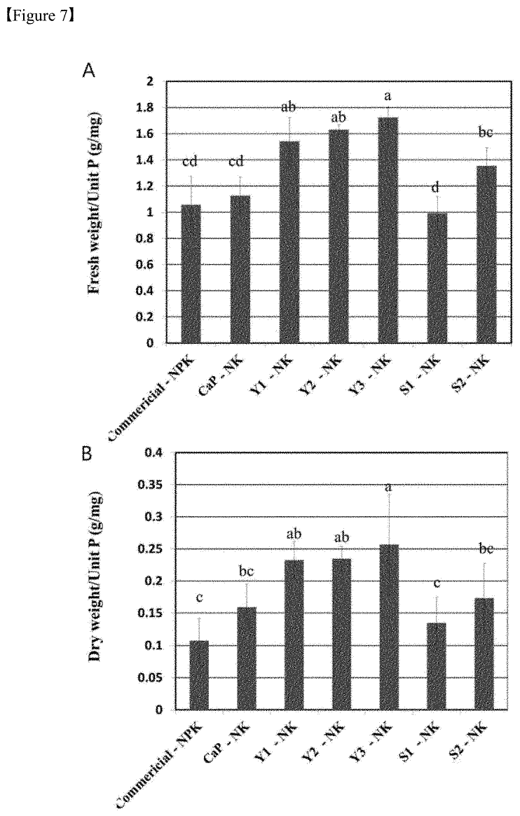

Furthermore, as a result of measuring the increased biomass per unit phosphorus(P) supplied to soil, an increase in the fresh weight(FIG. 7A) and dry weight(FIG. 7B) was observed from the group treated with CaP(NK) coated with commercially available humic acid or a phenolic polymer compared to the group treated with commercially available inorganic phosphorous fertilizer(NKP) and CaP(NK) treatment group, and in case of the commercially available humic acid, both the fresh weight and dry weight have significantly increased in the group treated with CaP(NK) coated with humic acid at concentration of 0.01 g/ml (Y1), 0.1 g/ml (Y2), or 0.05 g/ml (Y3). As for the phenolic polymer, it was confirmed that the fresh weight has increased in the group treated with CaP(NK) coated with a polymer of catechol and ferulic acid (S2) and a polymer of catechol and gallic acid (S1).

Based on the above results, it was recognized that, if CaP is coated with humic acid or a phenolic polymer, the fertilizer components can be gradually released over the growth period of a plant after just one application of a fertilizer, and, according to the enhanced solubilization of the phosphorus(P) contained in hydroxyapatite and possibly β-TCP by inducing surface modification, phosphorus required for plant growth can be supplied in sufficient amount. For statistical processing among different groups, LSD (p<0.05) was used.

### Example 7. Analysis of Effect of Plant Tolerance to Salt Stress According to Treatment with CaP Coated with Humic Acid or a Phenolic Polymer

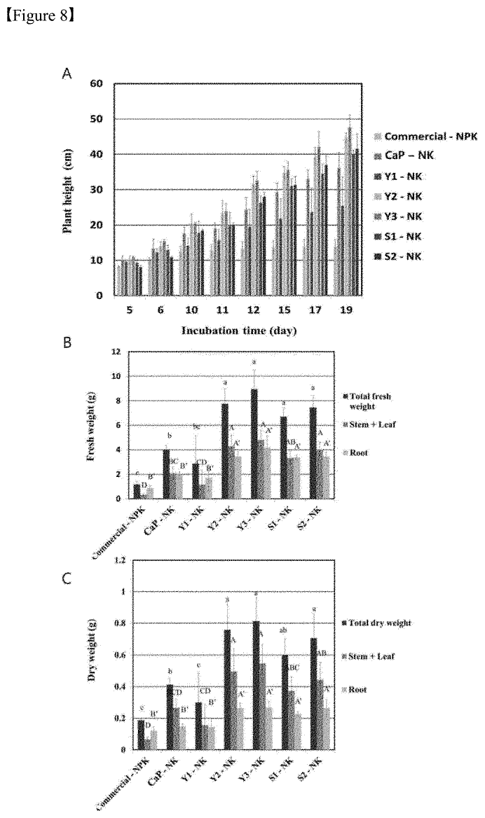

By using corn (Zea mays) as a model plant, the effect of enhancing the tolerance to salt stress by CaP that are coated with humic acid and a phenolic polymer was analyzed. As a result, it was confirmed that, compared to the group treated with commercially available inorganic phosphorus fertilizer(NKP) and CaP(NK), an increase in the plant height (FIG. 8A), fresh weight(FIG. 8B) and dry weight(FIG. 8C) of the corn is observed from the group treated with CaP(NK) coated with humic acid at concentration of 0.01 g/ml (Y1), 0.1 g/ml (Y2) or 0.05 g/ml (Y3), and also the group treated with CaP(NK) coated with a polymer of catechol and gallic acid (S1) and the group treated with CaP(NK) coated with a polymer of catechol and ferulic acid (S2), and the increase level was similar between the group treated with CaP(NK) coated with a phenolic polymer and the group treated with CaP(NK) coated with commercially available humic acid.

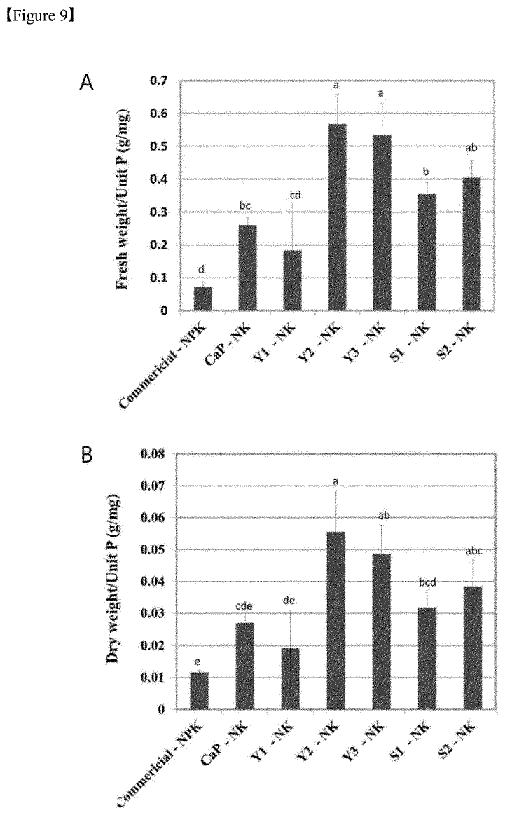

Furthermore, as a result of measuring the biomass per phosphorus unit supplied to soil, an increase in the fresh weight(FIG. 9A) and dry weight(FIG. 9B) was observed from the group treated with CaP(NK) coated with humic acid at concentration of 0.01 g/ml (Y1), 0.1 g/ml (Y2) or 0.05 g/ml (Y3), and also the group treated with CaP(NK) coated with a polymer of catechol and gallic acid (S1) or a polymer of catechol and ferulic acid (S2) compared to the group treated with commercially available inorganic phosphorus fertilizer(NKP) and CaP(NK), while the group treated with CaP(NK) coated with a phenolic polymer shows a slightly lower value compared to the group treated with CaP(NK) coated with humic acid.

These results indicate that, as humic acid or a phenolic polymer is released with solubilized phosphorus, the property of a plant showing phosphorus utilization efficiency and tolerance to a non-biological stress can be enhanced. For statistical processing among different groups, LSD (p<0.05) was used.

1. Hydroxyapatite coated with humic acid or a polymer of monomeric phenol.

2. The hydroxyapatite according to claim 1, wherein the polymer of monomeric phenol is a copolymer or a homopolymer of monomeric phenol.

3. The hydroxyapatite according to claim 1, wherein the polymer of monomeric phenol is a copolymer or a homopolymer produced by polymerizing monomeric phenols using an oxidizing agent.

4. The hydroxyapatite according to claim 3, wherein the polymer of monomeric phenol is a copolymer produced by polymerizing a mixture of catechol and gallic acid or a mixture of catechol and ferulic acid using an oxidizing agent.

5. The hydroxyapatite according to claim 3, wherein the oxidizing agent contains at least one selected from a group consisting of copper (I) chloride, ammonium persulfate, sodium periodate, potassium chloride, and an oxidizing enzyme.

6. The hydroxyapatite according to claim 5, wherein the oxidizing enzyme is a peroxidase, a laccase, or a mixture thereof.

7. The hydroxyapatite according to claim 1, wherein the hydroxyapatite is in mixture with a tricalcium phosphate coated with humic acid or a polymer of monomeric phenol.

8. The hydroxyapatite according to claim 7, wherein the hydroxyapatite and tricalcium phosphate are obtained from chemical synthesis or thermal treatment of bones.

9. A slow-releasing fertilizer composition comprising as an effective ingredient the hydroxyapatite coated with humic acid or a polymer of monomeric phenol of claim 1.

10. A fertilizer for increasing plant growth produced by using the slow-releasing fertilizer composition of claim 9.

11. A method for increasing plant growth comprising treating a plant, a seed of a plant, or soil for growing a plant with the fertilizer for increasing plant growth of claim 10.

12. A composition for increasing plant tolerance to salt stress comprising as an effective ingredient the hydroxyapatite coated with humic acid or a polymer of monomeric phenol of claim 1.

13. A fertilizer for increasing plant tolerance to salt stress produced by using the composition for increasing plant tolerance to salt stress of claim 12.

14. A method for increasing plant tolerance to salt stress comprising treating a plant, a seed of a plant, or soil for growing a plant with the fertilizer for increasing plant tolerance to salt stress of claim 13.
